(19) United States
(12) Patent Application Publication
(10) Pub. No.: US 2026/0080516 A1
(43) Pub. Date: Mar. 19, 2026

(54) Techniques for Adaptive Image Denoising

(71) Applicants: Nerhun Yildiz, Harrow (GB); William Dries, Eastleigh (GB)

(72) Inventors: Nerhun Yildiz, Harrow (GB); William Dries, Eastleigh (GB)

(21) Appl. No.: 19/399,258

(22) Filed: Nov. 24, 2025

(51) Int. Cl. G06T 5/70; G06T 5/20

(52) U.S. Cl. CPC G06T 5/70; G06T 5/20

(57) ABSTRACT

Systems and methods of the present disclosure provide a system that includes an image sensor that captures pixel data and a programmable logic device including programmable logic circuitry that is configurable to be programmed with a noise reduction circuit including a first bilateral filter and a second bilateral filter. The noise reduction circuit may filter a pixel value of the pixel data based on the first bilateral filter and the second bilateral filter.

### BACKGROUND

The present disclosure generally relates to integrated circuit devices, such as processors and/or field programmable gate arrays (FPGAs). More particularly, the present disclosure generally relates to integrated circuit devices that perform image denoising (e.g., image data denoising, noise reduction of images).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art

Integrated circuits are found in numerous electronic devices and provide a variety of functionality, such as image denoising. For example, image sensors may introduce various types of noise within images and/or videos captured. Thus, an integrated circuit may perform image denoising to reduce the noise present within the images and/or videos. However, some integrated circuits may perform image denoising indiscriminately, which may reduce image sharpness and/or suppress (e.g., mute) one or more regions of brightness (e.g., specular highlights, bright spots). For example, performing the image denoising indiscriminately to reduce noise in one or more regions of darkness of the image may result in softening details in the one or more regions of brightness. Conversely, performing the image denoising indiscriminately to maintain the details in the one or more regions of brightness may result in inadequate denoising for the one or more regions of darkness. Moreover, a manufacturer of many integrated circuits, such as FPGAs, may be unaware of various features that a customer may use in an imaging system that uses the integrated circuit. Different components of different overall systems, such as different camera image sensors, may differ in behavior. As such, an integrated circuit that performs denoising for one system may be inappropriate for other systems.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device;

FIG. 2 is a block diagram of an example of the integrated circuit device that may be programmed with the system design;

FIG. 3 is a block diagram of an adaptive noise reduction module that may be programmed into programmable logic of the integrated circuit device;

FIG. 4 is an example illustration of a graph indicative of an amount of noise per pixel value for one or more sensor analog gains;

FIG. 5 is an example illustration of a graph indicative of a noise total per pixel intensity for one or more filtering strengths;

FIG. 6 is a block diagram of an example bilateral filter employed by the adaptive noise reduction module;

FIG. 7 is an example illustration of a portion of embedded digital signal processing (DSP) blocks included in the bilateral filter that calculate an exponent of one or more exponents;

FIG. 8 is a flowchart of a method for programming a system design configuration into the integrated circuit device; and

FIG. 9 is a block diagram of a data processing system that may incorporate the systems and methods of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Embodiments described herein generally relate to techniques (e.g., systems and methods) for adjusting (e.g., adapting) a strength of a denoising algorithm based on an expected noise of an image and/or a pixel intensity. For example, an integrated circuit device may be programmed to include an adaptive noise reduction module. The integrated circuit device may employ the adaptive noise reduction module to denoise an image based on a first bilateral filter for a vertical orientation (e.g., pixel columns of the image) and a second bilateral filter for a horizontal orientation (e.g., rows of the image). Moreover, the adaptive noise reduction module may be programmed to employ a spatial distance lookup table (e.g., with pre-calculated spatial coefficients) and an intensity range lookup table (e.g., with pre-calculated intensity coefficients) to perform denoising operations with the first bilateral filter and the second bilateral filter. As such, the adaptive noise reduction module may adjust denoising operations based on an intensity of a pixel of interest (e.g., center pixel, a pixel that the denoising operations are being performed on) and an analog sensor gain (e.g., sensor amplification) for a particular image sensor providing the image data. In this manner, the adaptive noise reduction module may improve denoising performance while preserving details and/or textures of the image.

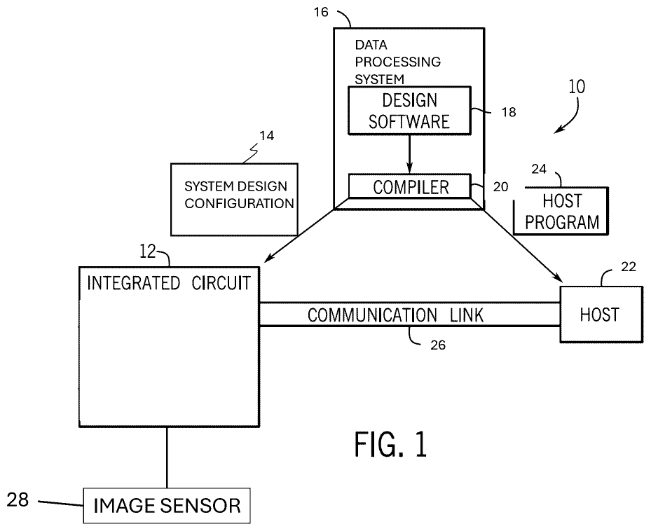

FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design using a system design configuration 14. Note that, while this disclosure largely refers to the integrated circuit device 12 as being a programmable logic device, such as an FPGA, in some embodiments, the integrated circuit device 12 may also include a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12.

Additionally or alternatively, the host 22 running the host program 24 may control or implement the system design configuration 14 into the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting. In some examples, the integrated circuit 12 may include or be coupled to an image sensor 28 that may capture and/or provide image data to the integrated circuit 12. In this manner, the integrated circuit 12 may denoise (e.g., by employing an adaptive noise reduction module) the image data received from and/or provided by the image sensor 28.

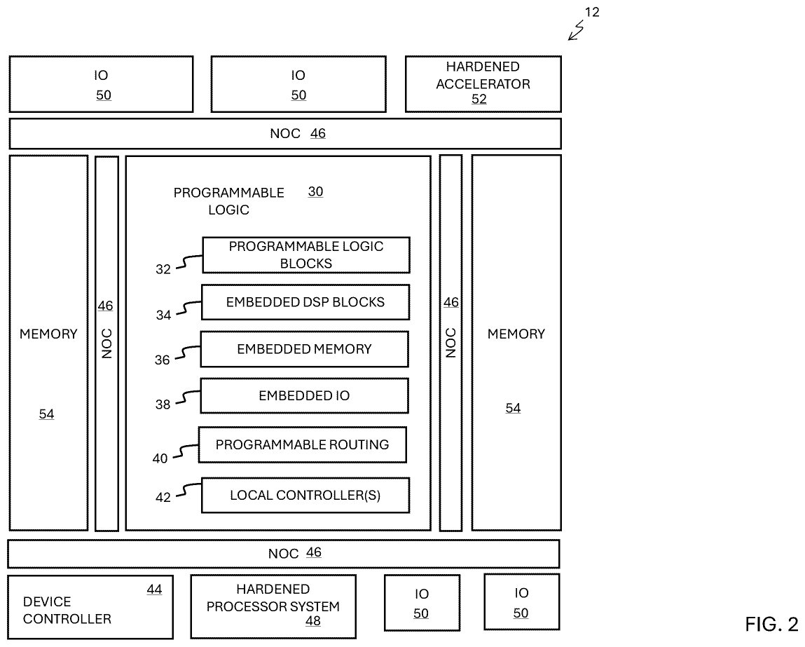

The integrated circuit device 12 may take any suitable form that may implement the system design configuration 14. In one example shown in FIG. 2, the integrated circuit device 12 may include programmable logic circuitry 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

To perform denoising, the integrated circuit device 12 may employ bilateral filtering (e.g., edge-preserving smoothing filtering) and/or other denoisers, such as Gaussian blur, a moving average, and so on. However, employing Gaussian blur and/or the moving average may be unilateral such that filtering coefficients are based on a spatial domain (e.g., spatial distances) between pixels (e.g., from a center pixel) within a pixel block (e.g., convolution window, kernel). However, the integrated circuit device 12 may employ bilateral filtering to account for the spatial domain and/or an intensity domain when determining filtering coefficients to apply to pixel data that corresponds to an image.

An example of bilateral filtering of the image may be defined according to Equations 1 and 2 below:

$${I}_{o} ( ψ ) = B ( {I}_{i} ( ψ ) ) = \frac{1}{{\sum }_{ξ} W ( {I}_{i} , ψ , ξ )} \times {\sum }_{ξ} W ( {I}_{i} ( ψ ) , ξ ) {I}_{i} ( ψ , ξ ) \qquad Equation 1$$

$$W ( {I}_{i} , ψ , ξ ) = f ( {I}_{i} ( ψ ) ) h ( ξ ) \qquad Equation 2$$

The integrated circuit device 12 may provide an output image (Iₒ) based on by applying a bilateral filter function (B) to an input image (Iᵢ) at a pixel of interest (ψ) that corresponds to a pixel coordinate. For example, the integrated circuit device 12 may provide the output image (Iₒ) based on a weight window (W), an (x, y) (e.g., x-coordinate and a y-coordinate) of a neighboring pixel (ξ) that neighbors the pixel of interest, an intensity coefficient (f), and/or a spatial coefficient (h). Further, the weight window (W) may be a function of both the pixel of interest (ψ) and the neighboring pixel coordinates (ξ), as well as the input image (Iᵢ), as shown in Equation 2 (W(Iᵢ, ψ, ξ)), which may make the weights different for each pixel of the input image (Iᵢ). Therefore, the integrated circuit device 12 may apply different weights to various pixels of the image, which may involve pixel-by-pixel normalization.

In some examples, the intensity coefficient (f), and/or the spatial coefficient (h) may be defined as Gaussian functions according to Equations 3 and 4 below:

$$f ( {I}_{i} ( ψ ) ) = g ( {I}_{i} ( ψ ) ) \qquad Equation 3$$

$$h ( ξ ) = h ( x , y ) = g ( x , y ) \qquad Equation 4$$

With (x₀, y₀) as a center coordinate, a standard deviation of intensity (σᵢ), a standard deviation of the spatial distance (σₛ), one-dimensional Gaussian functions and/or two-dimensional Gaussian functions (g) for the intensity domain and the spatial domain may be defined according to Equations 5 and 6 below:

$$f ( {I}_{i} ( ψ ) ) = g ( {I}_{i} ( ψ ) ) = {e}^{- \frac{{‖ {I}_{i} ( ψ ) - {I}_{i} ( ψ , ξ ) ‖}^{2}}{2 {σ}_{i}^{2}}} \qquad Equation 5$$

$$h ( ξ ) = h ( x , y ) = g ( x , y ) = {e}^{- \frac{{( x - {x}_{0} )}^{2}}{2 {σ}_{s}^{2}} - \frac{{( y - {y}_{0} )}^{2}}{2 {σ}_{s}^{2}}} \qquad Equation 6$$

By combining Equations 5 and 6, Equation 4 may be defined according to Equation 7 below:

$$W ( {I}_{i} , ψ , ξ ) = f ( {I}_{i} ( ψ ) ) h ( ξ ) = {e}^{- \frac{‖ {I}_{i} ( ψ ) - {I}_{i} ( ψ , ξ ) \vert {\vert}^{2}}{2 {σ}_{i}^{2}} - \frac{{( x - {x}_{0} )}^{2}}{2 {σ}_{s}^{2}} - \frac{{( y - {y}_{0} )}^{2}}{2 {σ}_{s}^{2}}} \qquad Equation 7$$

Thus, the standard deviation of the spatial distance (σₛ) may correspond to a size of the weight window (W). For example, a larger spatial distance may enable the integrated circuit device 12 to account for pixels farther away from the pixel of interest that are surrounding the pixel of interest. That is, the further the pixels away from the pixel of interest may have an influence. Alternatively, a smaller spatial distance may enable the integrated circuit device 12 to account for a small number of pixels (e.g., pixels nearby the pixel of interest) surrounding the pixel of interest. In addition, the standard deviation of the pixel intensity (σᵢ) may correspond to a desired brightness for a neighboring pixel to affect (e.g., influence) the pixel of interest. For example, a larger standard deviation of pixel intensity may enable neighboring pixels of larger differing intensities (e.g., different brightness) to affect the pixel of interest. Alternatively, a smaller standard deviation of pixel intensity may enable pixels of similar intensity to the pixel of interest to affect the pixel of interest. As such, the integrated circuit device 12 may employ bilateral filtering to prevent one or more dark (e.g., lower brightness) pixels and one or more bright (e.g., higher brightness as compared to the lower brightness) pixels to be averaged, which may prevent blurring of edges and textures of the image.

However, at times, the standard deviation of the spatial distance (σₛ) and the standard deviation of the pixel intensity (σᵢ) may be set at a constant value, which may result in inadequate denoising operations and/or a reduction in image sharpness (e.g., by causing a softening of image details). Therefore, embodiments described herein employ the standard deviation of the pixel intensity (σᵢ) to be a function of intensity as defined according to Equation 8 below:

$${σ}_{i} = {σ}_{i} ( {I}_{i} ( ψ ) ) = {σ}_{i} ( {I}_{i} ( {x}_{0} , {y}_{0} ) ) \qquad Equation 8$$

For imaging sensors, such as the image sensor 28, Equation 8 may include an approximation of dark noise and shot noise as defined according to Equation 9 below:

$${σ}_{i} ( {I}_{i} ( {x}_{0} , {y}_{0} ) ) = {σ}_{total} \approx \sqrt{{kI}_{i} ( {x}_{0} , {y}_{0} ) + {σ}_{dark}^{2}} \qquad Equation 9$$

Embodiments described herein enable constants (k) and

$${σ}_{dark}^{2}$$

to be calibrated per analog gain of each sensor model (e.g., for differing sensors, such as the image sensor 28). In some examples, the function of intensity (σᵢ(lᵢ(x₀, y₀))) may be associated with a curve that may correspond to (e.g., follow) a noise expectation of one or more differing use cases of sensors.

Moreover, performing bilateral filtering operations according to Equations 1 and 7 may involve an increase in computational resource usage (e.g., computationally intensive) and/or processing power. Moreover, bilateral filtering operations according to Equation 1 may be associated with a non-separable non-linear filter based on intensity awareness. In addition, the bilateral filtering operations according to Equation 1 may involve use of a single bilateral filter that employs large window sizes, such as a 9 by 9 pixel block, a 17 by 17 pixel block, and/or larger pixel blocks, to perform effective noise reductions. Therefore, it may be desirable to process an image using bilateral filters (e.g., two bilateral filters) corresponding to differing orientations (e.g., vertical orientation, horizontal orientation), instead of the single bilateral filter with multiple spatial dimensions (e.g., two spatial dimensions).

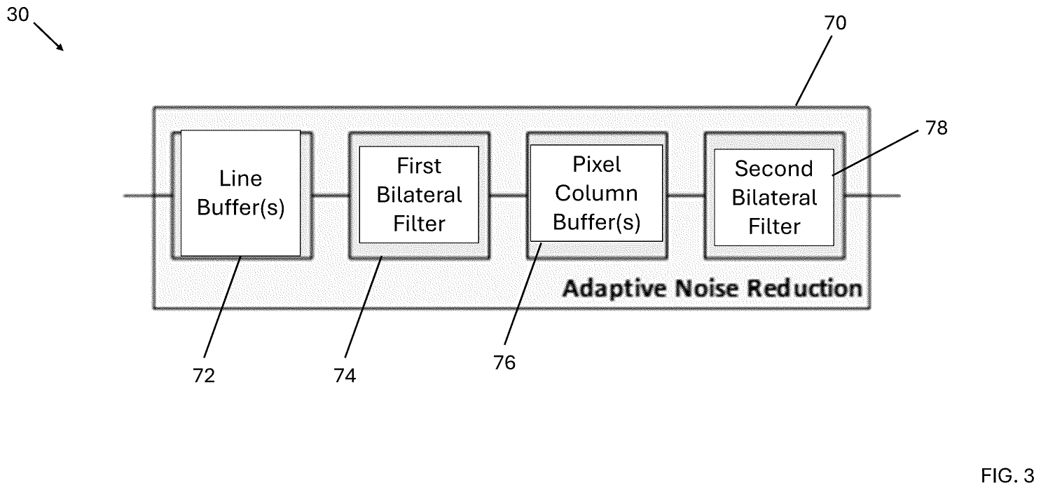

With the foregoing in mind, FIG. 3 is a block diagram of an adaptive noise reduction module 70 that may be programmed into the programmable logic circuitry 30 of the integrated circuit device 12. The adaptive noise reduction module 70 may include one or more line buffers 72, a first bilateral filter 74 (e.g., first one-dimensional bilateral filter), one or more pixel column buffers 76, and/or a second bilateral filter 78 (e.g., second one-dimensional bilateral filter). For example, the adaptive noise reduction module 70 may include the one or more line buffers 72, the first bilateral filter 74, the one or more pixel column buffers 76, and/or the second bilateral filter 78 based on the image data being in a raster scan order (e.g., packed row-wise in the raster scan order). The adaptive noise reduction module 70 may store pixel column data for one or more pixel columns (e.g., vertical columns of pixels of an image) in the one or more line buffers 72. Moreover, the adaptive noise reduction module 70 may employ the first bilateral filter 74 to process the pixel column data.

It should be noted that the adaptive noise reduction module 70 including the one or more line buffers 72, the first bilateral filter 74, the one or more pixel column buffers 76, and/or the second bilateral filter 78 is merely illustrative, and the adaptive noise reduction module 70 may include any suitable number of buffers and/or filters. In some examples, the adaptive noise reduction module 70 performing noise reduction may involve larger window sizes, such as a window size of 9 by 9, 17 by 17, or any suitable larger window size.

Additionally, the adaptive noise reduction module 70 may buffer the results of the first bilateral filter 74 horizontally by the window width. The adaptive noise reduction module 70 may employ the second bilateral filter 78 to process the pixel row data. In this manner, the adaptive noise reduction module 70 may process the image with two one-dimensional bilaterial filters in a vertical orientation (e.g., using the first bilateral filter 74) and/or in a horizontal orientation (e.g., using the second bilateral filter 78), which may be defined according to Equation 10 below:

$${\hat{I}}_{o} ( ψ ) = {B}_{h} ( {B}_{v} ( {I}_{i} ( ψ ) ) ) \qquad Equation 10$$

Indeed, the first bilateral filter 74 (Bᵥ) may be in the vertical dimension (x) and may be defined according to Equation 11 below:

$${I}_{j} ( ψ ) = {B}_{v} ( {I}_{i} ( ψ ) ) = \frac{1}{{\sum }_{x} W ( {I}_{i} , ψ , x )} \times {\sum }_{x} W ( {I}_{i} ( ψ ) , x ) {I}_{i} ( ψ , x ) \qquad Equation 11$$

Moreover, the second bilateral filter 78 (Bₕ) may be in the horizontal dimension (y) and may be defined according to Equation 12 below:

$${\hat{I}}_{o} ( ψ ) = {B}_{h} ( {I}_{j} ( ψ ) ) = \frac{1}{{\sum }_{y} W ( {I}_{j} , ψ , y )} \times {\sum }_{y} W ( {I}_{j} ( ψ ) , y ) {I}_{j} ( ψ , y ) \qquad Equation 12$$

It should be noted that, in some examples, due to non-linearity of bilateral functions, Equation 10 may not include a convolution operation. Therefore, in some examples, an intensity with noise (Îₒ) may not be equal to the output image (Iₒ). Moreover, in some examples, denoising performance of the adaptive noise reduction module 70 may be similar when performing bilateral filtering operations according to Equations 1 and 10 when the standard deviation of the spatial distance (σₛ) is adjusted for a difference in a number of pixels averaged (e.g., with occasional edge artifacts when employing equation 10). However, because employing Equation 10 causes computational complexity to linearly scale with window size (e.g., as opposed to quadratically in Equation 1), employing Equation 10 may reduce computational resource usage by the adaptive noise reduction module 70 and/or the integrated circuit device 12. Therefore, by employing Equation 10 for bilateral filtering operations and noise reduction, the adaptive noise reduction module 70 may reduce computational resource usage and improve efficiency in processing operations.

Additionally or alternatively, the adaptive noise reduction module 70 may adjust (e.g., or be configurable to adjust) bilateral filtering operations based on a particular architecture of the integrated circuit device 12. For example, a vertical window for vertical filtering by the first bilateral filter 74 may be defined according to Equation 13 below:

$${W}_{v} ( {I}_{i} , {x}_{0} , {y}_{0} , x ) = f ( {I}_{i} ( {x}_{0} , {y}_{0} ) ) {h}_{v} ( x ) = {e}^{- \frac{{‖ {I}_{i} ( {x}_{0} , {y}_{0} ) - {I}_{i} ( x , {y}_{0} ) ‖}^{2}}{2 {{σ}_{i} ( {I}_{i} ( {x}_{0} , {y}_{0} ) )}^{2}} - \frac{{( x - {x}_{0} )}^{2}}{2 {σ}_{s}^{2}}} \qquad Equation 13$$

Moreover, in a one-dimensional space (e.g., in one dimension of space) the spatial distance may be defined according to Equation 14 below:

$${W}_{v} ( {I}_{i} , {x}_{0} , {y}_{0} , x ) = {e}^{- \frac{{( {I}_{i} ( {x}_{0} , {y}_{0} ) - {I}_{i} ( x , {y}_{0} ) )}^{2}}{2 {{σ}_{i} ( {I}_{i} ( {x}_{0} , {y}_{0} ) )}^{2}} - \frac{{( x - {x}_{0} )}^{2}}{2 {σ}_{s}^{2}}} \qquad Equation 14$$

It should be noted that the integrated circuit device 12 may be programmed to include a system design configuration that includes one or more lookup tables specific to image sensor gain. For example, a first lookup table of the one or more lookup tables may include an intensity range lookup table with intensity coefficients (Lᵢ), which may be defined according to Equation 15 below:

$${L}_{i} = {L}_{i} ( {I}_{i} , {x}_{0} , {y}_{0} ) = \frac{1}{\sqrt{2} {σ}_{i} ( {I}_{i} ( {x}_{0} , {y}_{0} ) )} \qquad Equation 15$$

Moreover, a second lookup table of the one or more lookup tables may include a spatial distance lookup table with spatial coefficients (Lₛ), which may be defined according to Equation 16 below:

$${L}_{s} = {L}_{s} ( {x}_{0} , x ) = \frac{{( x - {x}_{0} )}^{2}}{2 {σ}_{s}^{2}} \qquad Equation 16$$

Further, Equation 14 may be rewritten (e.g., based on Equations 15 and 16) and defined (e.g., for the vertical orientation calculations) according to Equations 17 and 18 below:

$${W}_{v} ( {I}_{i} , {x}_{0} , {y}_{0} , x ) = {e}^{- ( {{L}_{i}^{2} ( {I}_{i} ( {x}_{0} , {y}_{0} ) - {I}_{i} ( x , {y}_{0} ) )}^{2} + {L}_{s} )} \qquad Equation 17$$

$${W}_{v} ( {I}_{i} , {x}_{0} , {y}_{0} , x ) = {e}^{- ( {( {L}_{i} {I}_{i} ( {x}_{0} , {y}_{0} ) - {L}_{i} {I}_{i} ( x , {y}_{0} ) )}^{2} + {L}_{s} )} \qquad Equation 18$$

It should be noted that the intensity range lookup table and/or the spatial distance lookup table may include pre-calculated values that may be updated externally (e.g., by a designer, operator, or any other suitable user) to adjust a strength of bilateral filtering for denoising in the intensity domain and/or the spatial domain. Moreover, the values of the intensity range lookup table and/or the spatial distance lookup table may be adjusted (e.g., by any suitable user) to increase flexibility and/or reduce computational resource usage by the integrated circuit device 12. It should be noted that similar Equations may be employed for the horizontal orientation calculations.

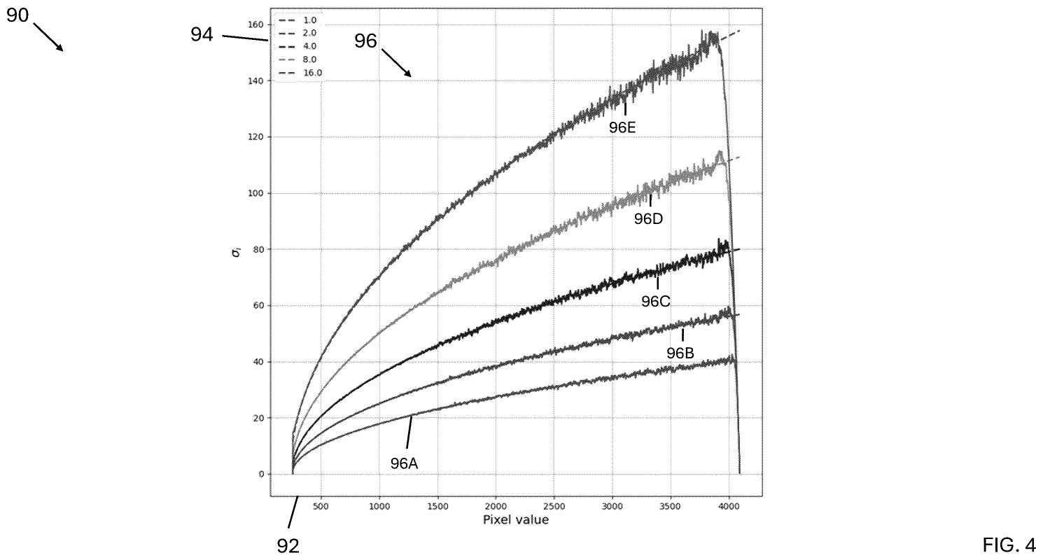

FIG. 4 is an example illustration of a graph 90 indicative of an amount of noise per pixel value (as indicated by axis 92) per pixel value (e.g., as indicated by axis 94). The graph 90 may include one or more lines 96 corresponding to various sensor analog gains of one or more analog gains. For example, a first line 96A may correspond to a first sensor analog gain (e.g., 1.0), a second line 96B may correspond to a second analog gain (e.g., 2.0), a third line 96C may correspond to a third analog gain (e.g., 4.0), a fourth line 96D may correspond to a fourth analog gain (e.g., 8.0), and a fifth line 96E may correspond to a fifth analog gain (e.g., 16.0).

A standard deviation of dark noise and/or shot noise of an image may be combined as a noise total (σₜₒₜₐₗ), which may be defined according to Equation 19 below:

$${σ}_{total} \approx \sqrt{kI + {σ}_{dark}^{2}} \qquad Equation 19$$

In Equation 19, the noise total (σₜₒₜₐₗ) may be based on a combined gain (k), an intensity (I) of the pixel of interest, and a standard deviation of dark noise

$${σ}_{dark}^{2}$$

It should be noted that, in some examples, parameters of Equation 19 may be adjusted based on a curve (e.g., instead of a square root function). Moreover, as described herein, controlling a noise distribution may be based on an input from any suitable user (e.g., designer, operator, and/or any other suitable user) that describes noise for a particular image sensor, such as the image sensor 28. For example, the input may correspond to information, such as a calibration profile, regarding how to calibrate a particular product for the particular image sensor. For example, at least some of the information may be associated with an intensity-noise relationship, such as the relationships shown in the graph 90 of FIG. 4.

That is, the graph 90 corresponds to the image sensor (e.g., 12-bit image sensor) that has been calibrated (e.g., received information regarding the calibration profile) for the various sensor analog gains in accordance with embodiments described herein. Moreover, each of the one or more lines 96 may correspond to respective noise measurements (e.g., with broken lines being based on best fits to data). It should be noted that falloffs of measurements at the end of each of the one or more lines 96 may be ignored as they pertain to saturation artifacts.

It should be noted that the intensity (I) of Equation 19 above is a signal corresponding to the image without noise, which a denoising algorithm may attempt to resolve. It should be noted that the intensity with noise (Îᵢ) may be defined according to Equation 20 below:

$${\hat{I}}_{i} = I + ϵ \qquad Equation 20$$

Thus, the intensity with noise (Îᵢ) may be based on the intensity (I) and an absolute noise (∈) on any given pixel. As such, any Equation that employs the intensity with noise (Îᵢ) may read an expected noise value that may be different from an actual noise value. Therefore, denoising algorithms may account for the difference (e.g., when there is a high signal-to-noise ratio, such as a low analog gain and a long exposure time; when there is a low signal-to-noise ratio, such as a high analog gain). However, the denoising algorithms may be unable to distinguish the noise of the image from details and/or textures of the image. Thus, embodiments described herein may enable the adaptive noise reduction module 70 to accurately distinguish the noise from the details and/or textures of the image (e.g., based on the information and/or calibration of the integrated circuit device 12 for the particular image sensor, such as the image sensor 28). Further, it should be noted that embodiments described herein may apply to any suitable type of noise with strength that scales based on pixel intensity (e.g., Joint Photographic Experts Group (JPEG) compression artifacts).

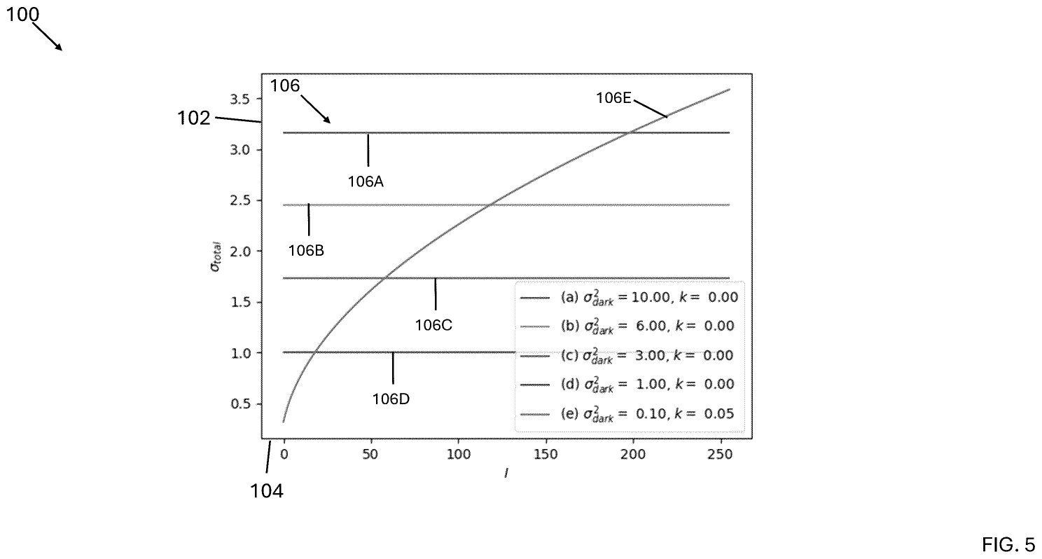

FIG. 5 is an example illustration of a graph 100 indicative of the noise total (σₜₒₜₐₗ) (as indicated by axis 102) per pixel intensity (I) (as indicated by axis 104) for one or more filtering strengths. The graph 100 may include one or more lines 106 corresponding to the one or more filtering strengths. For example, a first line 106A may correspond to a first filtering strength

$$( e . g . , {σ}_{dark}^{2} = 10. ) , ,$$

a second line 106B may correspond to a second filtering strength

$$( e . g . , {σ}_{dark}^{2} = 6. ) ,$$

a third line 106C may correspond to a third filtering strength

$$( e . g . , {σ}_{dark}^{2} = 3. ) ,$$

a fourth line 106D may correspond to a fourth filtering strength

$$( e . g . , {σ}_{dark}^{2} = 1. ) .$$

For the first filtering strength, the second filtering strength, the third filtering strength, and/or the fourth filtering strength, the combined gain (k) may be set at zero, which may result in application of a constant denoising strength.

However, embodiments described herein may be associated with a fifth line 106E that may correspond to a fifth filtering strength. In the illustrated example, the combined gain (k) may be set (e.g., calibrated) at 0.5. Moreover, as illustrated in FIG. 5, the fifth filtering strength may be modulated based on the pixel intensity (e.g., instead of applying the constant denoising strength). Therefore, embodiments described herein may enable the adaptive noise reduction module 70 to improve a denoising performance of the image while preserving details and/or texture of the image.

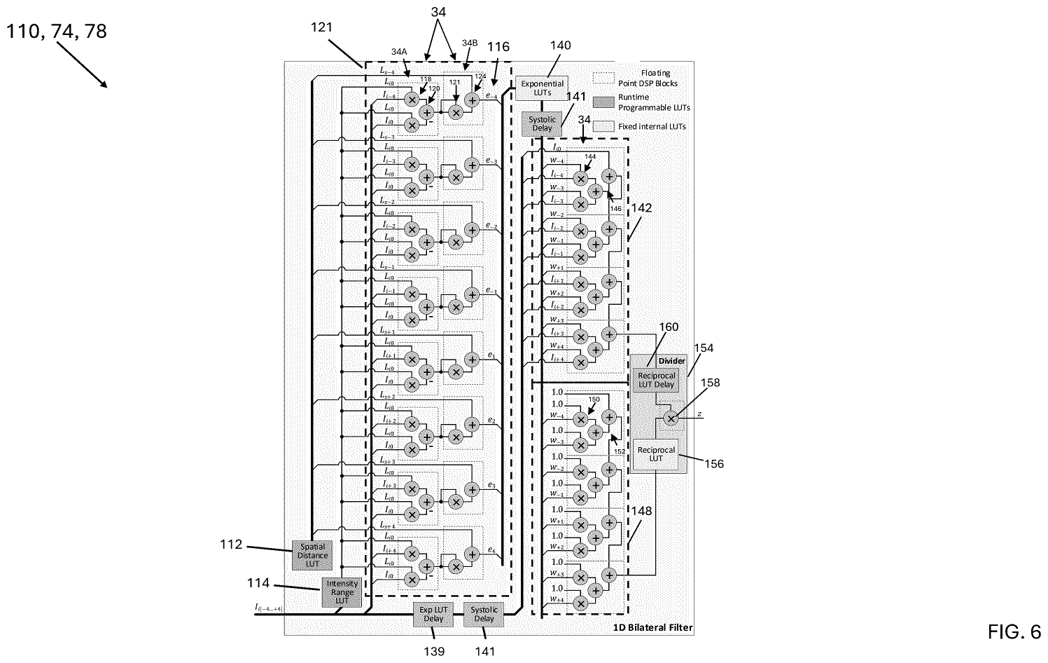

As described herein, the adaptive noise reduction module 70 may employ the first bilateral filter 74 and/or the second bilateral filter 78 when performing denoising operations. Therefore, FIG. 6 is a block diagram of a bilateral filter 110 employed by the adaptive noise reduction module 70. For example, the first bilateral filter 74 may include the same or similar components and/or may be the same or similar to the bilateral filter 110 and/or the second bilateral filter 78 may include the same and similar components and/or be the same or similar to the bilateral filter 110.

As illustrated in FIG. 6, the bilateral filter 110, 74, 78 may include a spatial distance lookup table 112 and/or an intensity range lookup table 114. As previously noted, the spatial distance lookup table 112 and/or the intensity range lookup table 114 may be pre-programmed (e.g., calibrated) into the integrated circuit device 12 by any suitable user (e.g., designer, operator, and so on). The spatial distance lookup table 112 may include one or more pre-calculated spatial coefficients. Moreover, the intensity range lookup table 114 may include one or more pre-calculated intensity coefficients. By employing the spatial distance lookup table 112 and/or the intensity range lookup table 114, the bilateral filter 110, 74, 78 may adjust a bilateral strength of the denoising operations in the spatial domain and the intensity domain.

It should be noted that parameters (e.g., values, coefficients) of the spatial distance lookup table 112 and/or the intensity range lookup table 114 may be based on a difference of noise between a first video frame and a second video frame (e.g., from a still scene). For example, the user may employ any suitable computing device to determine the parameters of the spatial distance lookup table 112 and/or the intensity range lookup table 114. If the difference between each pixel of the first video frame and the second video frame are grouped by pixel intensity, then a standard deviation of the differences per pixel intensity may result in the graph 90 of FIG. 4. It should be noted that the standard deviation of the differences may be scaled by dividing the differences by a square root of 2 (e.g., to normalize the differences). The expected noise σᵢ(Iᵢ(x₀, y₀)) may be represented with two floating point values, the combined gain (k), and the dark noise variance

$$( {σ}_{dark}^{2} )$$

by fitting a square-foot curve to sample points. In addition, the dark noise variance

$$( {σ}_{dark}^{2} )$$

may be accurately estimated by capturing a dark frame (e.g., an entirely dark frame, a completely dark frame). The process described herein may be repeated for a range of sensor analog gains (e.g., as illustrated in the graph 90 of FIG. 4).

The spatial distance lookup table 112 may be based on (e.g., generated based on) Equation 15 described herein with a window (e.g., Gaussian window). It should be noted that any suitable type of window may be employed to generate the spatial distance lookup table 112, such as a Hamming window, a Hanning window, or the like, to reduce image artifacts (e.g., ringing artifacts). Moreover, generating or assigning a same or similar value to each lookup table entry of the spatial distance lookup table 112 may enable (e.g., create) a rectangular distribution that increase denoising capabilities when the image artifact introduced is preferable over the image noise.

Moreover, the intensity range lookup table 114 may be based on (e.g., generated based on) Equation 16 described herein for a particular sensor analog gain of the range of sensor analog gains. In some examples, the intensity range lookup table 114 be adjusted (e.g., tuned) by reducing a level of expected noise for one or more dark regions of the image. As an example, the intensity range lookup table 114 may be adjusted if the output is High Dynamic Range (HDR) content compressed with a steep Perceptual Quantizer (PQ) curve causes the one or more dark regions to become amplified such that denoising may increase softening of image details and/or reduce image sharpness. As such, embodiments described herein may enable the spatial distance lookup table 112 and/or the intensity range lookup table 114 to be programmed based on expected noise that occurs due to amplification of the image sensor 28.

Referring back to FIG. 6, the spatial distance lookup table 112 may provide one or more spatial coefficients (e.g., pre-calculated spatial values) to the embedded DSP blocks 34. It should be noted that the bilateral filter 110, 74, 78 may omit calculation for a center pixel, because a difference with itself is equal to a value of 0 and an exponent raised to the power of the value of 0 is a value of 1. The bilateral filter 110, 74, 78 may employ the embedded DSP blocks 34 to determine (e.g., calculate) one or more exponents 116. For example, the bilateral filter 110, 74, 78 may include a first number of embedded DSP blocks 34A and a second number of embedded DSP blocks 34B to determine the one or more exponents 116. The first number of embedded DSP blocks 34A may include one or more multipliers 118 and/or one or more adders 120. Further, the second number of embedded DSP blocks 34B may include one or more multipliers 122 and one or more adders 124. In some examples, the one or more multipliers 118 and/or the one or more multipliers 122 may include brain floating point (bfloat) multipliers (e.g., 16 bits or larger).

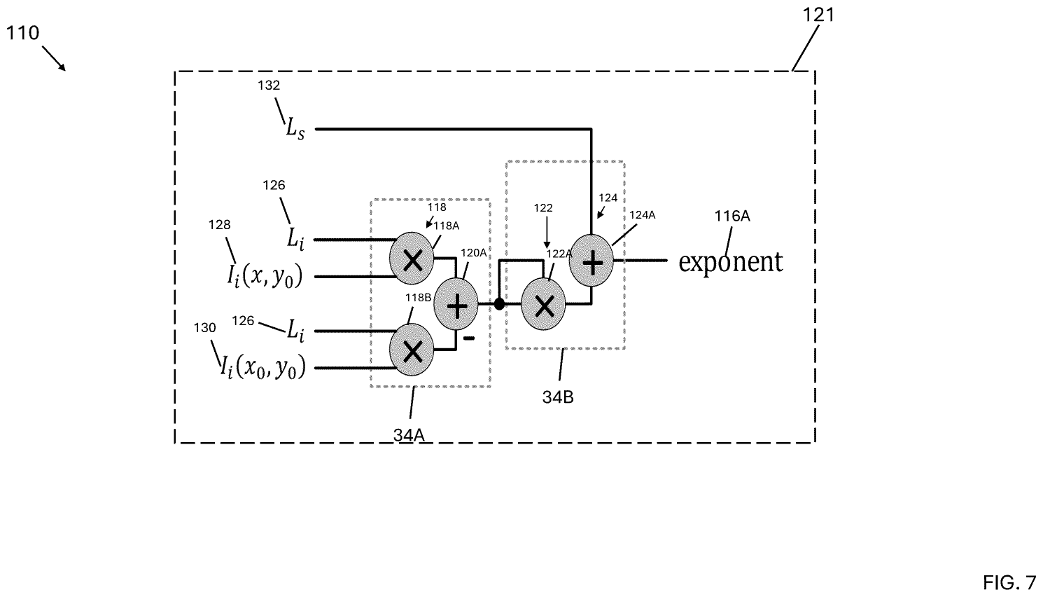

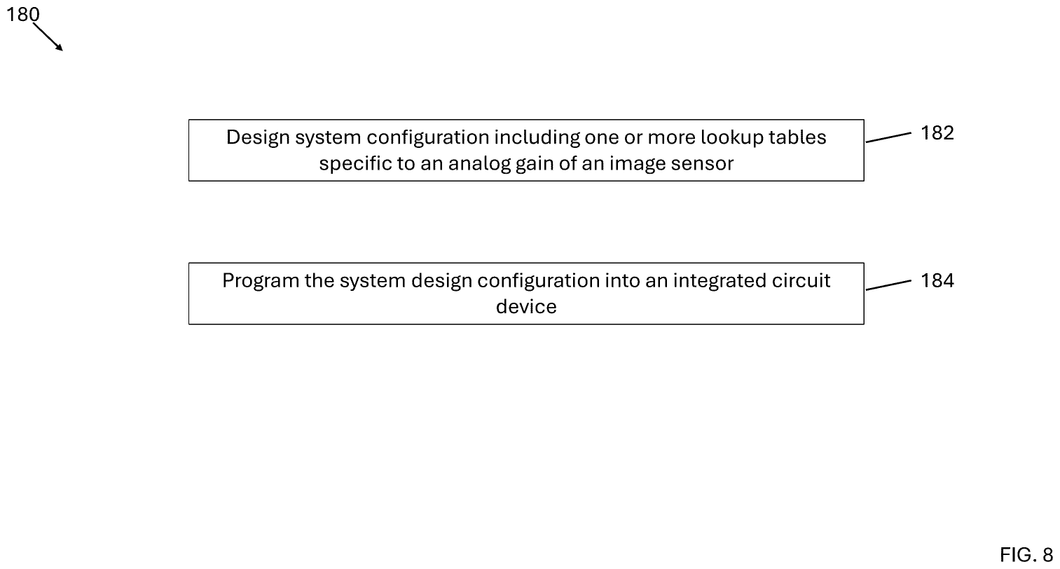

For example, FIG. 7 is an example illustration of the first portion 121 of the bilateral filter 110, which may include a sub-portion of the embedded DSP blocks 34 of the bilateral filter 110, 74, 78. As illustrated in FIG. 8, the first number of embedded DSP blocks 34A may include a first embedded DSP block 34A and the second number of embedded DSP blocks 34B may include a second embedded DSP block 34B. In some examples, the first embedded DSP block 34A and the second embedded DSP block 34B may operate as a two-multiply-add DSP macro block. The first embedded DSP block 34A may include the one or more multipliers 118, which may include a first multiplier 118A and a second multiplier 118B, and the one or more adders 120, which may include a first adder 120A. Additionally, the second embedded DSP block 34B may include the one or more multipliers 122, which may include a first multiplier 122A, and the one or more adders 124, which may include a first adder 124A to produce a first exponent 116A of the one or more exponents 116. The first multiplier 118A of the first embedded DSP block 34A may receive an intensity coefficient 126 from the intensity range lookup table 114 and an intensity value of a neighboring pixel 128 that neighbors (e.g., surrounds) a pixel of interest (e.g., center pixel) that the adaptive noise reduction module 70 is performing denoising operations for.

The first multiplier 118A may multiply the intensity coefficient 126 by the intensity value of the neighboring pixel 128 to output a first value. Moreover, the second multiplier 118B of the first embedded DSP block 34A may receive the intensity coefficient 126 and an intensity value of the pixel of interest 130. The second multiplier 118B may multiply the intensity coefficient 126 by the intensity value of the pixel of interest 130 to output a second value. The first adder 120A of the first embedded DSP block 34A may receive the first value and the second value and subtract the first value from the second value to output a first result value. The first multiplier 122A of the second embedded DSP block 34B may receive the first result value and square the first result value. Moreover, the first adder 124A of the second embedded DSP block 34B may receive the squared value from the first multiplier 122A and add a spatial coefficient 132 from the spatial distance lookup table 112 to the squared value to output the first exponent 116A.

With the foregoing in mind, and referring back to FIG. 6, the bilateral filter 110, 74, 78 may include several sub-portions within the first portion 121, with each sub-portion including a respective first embedded DSP block 34A and a respective second embedded DSP block 34B, which may together determine respective exponents 116 for differing neighboring pixels (e.g., with different spatial distances from the pixel of interest and/or different intensities from the pixel of interest). For example, the bilateral filter 110, 74, 78 may be based on a pixel window with a height value of 9 and a width value of 9. However, it should be noted that the pixel window may be any suitable height value and width value. In the illustrated example of FIG. 6, the bilateral filter 110, 74, 78 may determine eight exponents 116 based on the pixel window. Moreover, it should be noted that the bilateral filter 110, 74, 78 may determine each of the one or more exponents 116 based on Equation 18 previously described herein.

The bilateral filter 110, 74, 78 may include an exponential lookup table 140 that may determine (e.g., calculate) one or more weights based on the one or more exponents 116. For example, the bilateral filter 110, 74, 78 may employ the exponential lookup table 140 to map the one or more exponents 116 to output the one or more weights which correspond to the one or more exponents 116 raised to a negative exponent (e.g., by taking negative powers of the one or more exponents 116). In some examples, the bilateral filter 110, 74, 78 may include one or more delay registers that may enable matching of pipelining stages for the bilateral filter 110, 74, 78. Moreover, the bilateral filter 110, 74, 78 may implement an exponential lookup table delay 139 (e.g., latency that may be measured in clock cycles), and one or more systolic delays 141 (e.g., latency that may be measured in clock cycles) when implementing the first portion 121. The bilateral filter 110, 74, 78 may provide the one or more weights (w), the intensity of the pixel of interest, and the intensity of each of the different pixels within the pixel window that neighbor the pixel of interest to a second portion 142 of the bilateral filter 110, 74, 78 that may include a chain (e.g., systolic chain) of embedded DSP blocks 34.

Each of the embedded DSP blocks 34 of the second portion 142 may include respective multipliers 144 and respective adders 146 that the bilateral filter 110, 74, 78 may employ to determine a weighted average based on the one or more weights, the intensity of the pixel of interest, and the intensity of each of the different neighboring pixels. Moreover, a third portion 148 of the bilateral filter 110, 74, 78 may include respective embedded DSP blocks 34 with respective multipliers 150 and respective adders 152. The bilateral filter 110, 74, 78 may employ the third portion 148 to sum the one or more weights for normalization. It should be noted that denoising operations associated with the second portion 142 and/or the third portion 148 of the bilateral filter 110, 74, 78 may correspond to Equations 11 or 12 described above (e.g., for vertical filtering or horizontal filtering).

The bilateral filter 110, 74, 78 may provide the weighted average from the second portion 142 and the normalized one or more weights from the third portion 148 to a divider 154. The divider 154 may determine one or more reciprocals and perform normalization by employing a reciprocal lookup table 156 and a multiplier 158 for the weight average and the normalized one or more weights. In some examples, the divider 154 may include a reciprocal lookup table delay 160 (e.g., latency that may be measured in clock cycle). The divider 154 may then output a filtered (e.g., denoised) pixel value corresponding to the pixel of interest. It should be noted that the adaptive noise reduction module 70 may employ the bilateral filter 110, 74, 78 for each respective pixel value to determine the denoised pixel value for each respective pixel value. For example, the adaptive noise reduction module 70 may employ the bilateral filter 110, 74, 78 for each respective pixel value in a raster scan order.

In some examples, the image sensor 28 may be associated with a color filter array (e.g., Bayer pattern), where each pixel may alternate in color with a particular period. Thus, the adaptive noise reduction module 70 may perform denoising operations by employing same color channels (e.g., while skipping over other color channels) for the vertical orientation and/or the horizontal orientation. Moreover, in some examples, the adaptive noise reduction module 70 may account for diagonal entries for viable color channels. Additionally, in some examples, the adaptive noise reduction module 70 may be employed to reduce noise for any suitable data (e.g., other than pixel data) that is one-dimensional data or multi-dimensional data (e.g., two or more-dimensional data). For example, the adaptive noise reduction module 70 may reduce noise in volumetric data (e.g., three-dimensional data) and/or any other suitable data with additional dimensions. Further, computational complexity may increase linearly with an increasing number of dimensions.

FIG. 8 is a flowchart of a method 180 for programming a system design configuration into the integrated circuit device 12. The steps of the method 180 may be carried out by the system 10, which may include the integrated circuit device 12, the data processing system 16 (e.g., the design software 18 and/or the compiler 20), and/or the host 22. At process block 182, the system 10 may design a system configuration including one or more lookup tables (e.g., the spatial distance lookup table 112 and/or the intensity range lookup table 114) specific to an analog gain of an image sensor (e.g., the image sensor 28). For example, the system 10 may generate the system configuration based on user inputs, an automated design tool, or a combination of the user inputs and automated processes. For example, a user (e.g., designer, operator, or any other suitable user) may specify system parameters, such as lookup table entries (e.g., via graphical user interface and/or other design environment tools). Moreover, the system design configuration may be based at least in part on automated and/or compilation tools that process the user inputs to generate the one or more lookup tables and/or configuration data.

At process block 184, the system 10 may program the system design configuration into the integrated circuit device 12. For example, the system 10 may load configuration data (e.g., configuration bitstream) associated with the system design configuration into the integrated circuit device 12. In this manner, the integrated circuit device 12 may employ the one or more lookup tables to perform the denoising operations described above. In this manner, the integrated circuit device 12 may employ the one or more lookup tables to modulate denoising strength pixel-by-pixel based on an expected noise of a given pixel and a function of an intensity of the particular pixel being denoised.

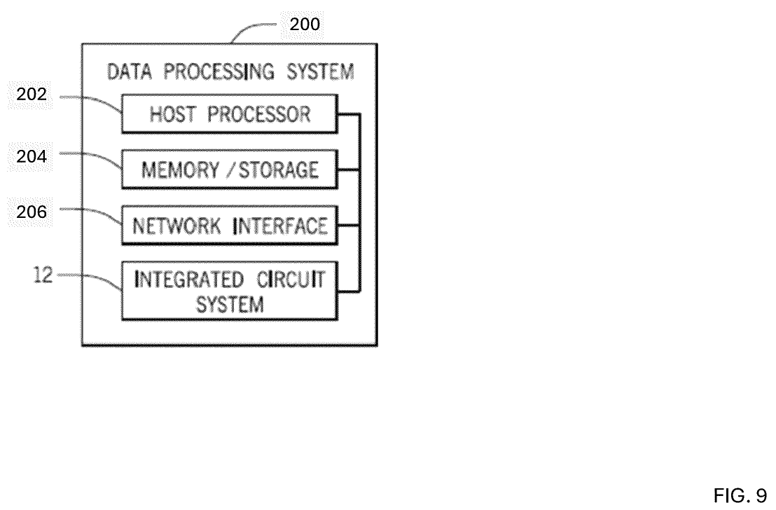

The processes discussed above may be carried out on the integrated circuit system 12, which may be a component included in a data processing system, such as a data processing system 200, shown in FIG. 9. The data processing system 200 may include the integrated circuit system 12 (e.g., a programmable logic device), a host processor 202, memory and/or storage circuitry 204, and a network interface 206. The data processing system 200 may include more or fewer components (e.g., electronic display, user interface structures, application specific integrated circuits (ASICs)). The host processor 202 may include any of the foregoing processors that may manage a data processing request for the data processing system 200 (e.g., to perform elaboration and simulation, to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 204 may include random access memory (RAM), read-only memory (ROM), one or more hard drives, flash memory, or the like. The memory and/or storage circuitry 204 may hold data to be processed by the data processing system 200. In some cases, the memory and/or storage circuitry 304 may also store configuration programs (e.g., bitstreams, mapping function) for programming the integrated circuit system 12. The network interface 206 may allow the data processing system 200 to communicate with other electronic devices. The data processing system 200 may include several different packages or may be contained within a single package on a single package substrate. For example, components of the data processing system 200 may be located on several different packages at one location (e.g., a data center) or multiple locations. In another example, components of the data processing system 200 may be located in separate geographic locations or areas, such as cities, states, or countries.

The data processing system 200 may be part of a data center that processes a variety of different requests. For example, the data processing system 200 may receive a data processing request via the network interface 206 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### Example Embodiment 1

A system including an image sensor configurable to capture pixel data, and a programmable logic device including programmable logic circuitry configurable to be programmed with a noise reduction circuit including a first bilateral filter and a second bilateral filter, the noise reduction circuit configurable to filter a pixel value of the pixel data based on the first bilateral filter and the second bilateral filter.

### Example Embodiment 2

The system of example embodiment 1, wherein the programmable logic circuitry is configurable to be programmed with a spatial distance lookup table including spatial coefficients and an intensity range lookup table including intensity coefficients.

### Example Embodiment 3

The system of example embodiment 2, wherein the spatial distance lookup table and the intensity range lookup table correspond to an analog gain of the image sensor.

### Example Embodiment 4

The system of example embodiment 4, wherein the noise reduction circuit is configurable to determine a number of weights based on the number of exponents, determine a weighted average based on the number of weights, and filter the pixel value based at least on part on the weighted average.

### Example Embodiment 5

The system of example embodiment 1, wherein the noise reduction circuit is configurable to filter the pixel value to reduce an amount of noise present in an image corresponding to the pixel data.

### Example Embodiment 6

The system of example embodiment 1, wherein the noise reduction circuit is configurable to filter the pixel data comprising one-dimensional pixel data or multi-dimensional pixel data.

### Example Embodiment 7

The system of example embodiment 1, wherein the first bilateral filter is associated with a vertical orientation and the second bilateral filter is associated with a horizontal orientation.

### Example Embodiment 8

The system of example embodiment 1, wherein the first bilateral filter is configurable to filter pixel column data of the pixel data and the second bilateral filter is configurable to filter pixel row data of the pixel data.

### Example Embodiment 9

The system of example embodiment 1, wherein the noise reduction circuit is configured to adjust a filtering strength applied to the pixel value when filtering the pixel value based on an intensity of the pixel value.

### Example Embodiment 10

The system of example embodiment 1, wherein the first bilateral filter, the second bilateral filter, or both include one or more embedded digital signal processing blocks with one or more multipliers and one or more adders to filter the pixel value.

### Example Embodiment 11

One or more tangible, non-transitory, computer-readable media including instructions that, when executed by a data processing system, cause the data processing system to carry out operations including store pixel data associated with an image, filter the pixel data based on a first bilateral filter, a second bilateral filter, one or more spatial coefficients, and one or more intensity coefficients, and output the filtered pixel data to facilitate a reduction of noise present in the image.

### Example Embodiment 12

The one or more tangible, non-transitory, computer-readable media of example embodiment 11, wherein the one or more spatial coefficients are associated with a spatial distance lookup table and the one or more intensity coefficients are associated with an intensity range lookup table.

### Example Embodiment 13

The one or more tangible, non-transitory, computer-readable media of example embodiment 12, wherein the spatial distance lookup table and the intensity range lookup table are associated with an analog sensor gain of an image sensor that captured the image.

### Example Embodiment 14

The one or more tangible, non-transitory, computer-readable media of example embodiment 11, wherein the instructions cause the data processing system to carry out operations including adjusting a filtering strength of the pixel data based on an expected amount of noise of the image and pixel intensity of the pixel data.

### Example Embodiment 15

The one or more tangible, non-transitory, computer-readable media of example embodiment 11, wherein the instructions cause the data processing system to carry out operations including adjusting a filtering strength of the pixel data based on an analog sensor gain of an image sensor that captured the image.

### Example Embodiment 16

The one or more tangible, non-transitory, computer-readable media of example embodiment 11, wherein the instructions cause the data processing system to carry out operations including storing pixel column data of the pixel data in a line buffer, and storing pixel row data of the pixel data in a pixel column buffer.

### Example Embodiment 17

The one or more tangible, non-transitory, computer-readable media of example embodiment 11, wherein the first bilateral filter is associated with a vertical orientation and the second bilateral filter is associated with a horizontal orientation.

### Example Embodiment 18

A method including using a system design tool or a programmable logic device compiler to generate one or more lookup tables that are to be programmed into a programmable logic device, and using the system design tool or the programmable logic device compiler to generate a system design including a noise reduction circuit configurable to filter a pixel value based on the one or more lookup tables.

### Example Embodiment 19

The method of example embodiment 18, wherein a first lookup table of the one or more lookup tables includes a spatial distance lookup table and a second lookup table of the one or more lookup tables includes an intensity range lookup table.

### Example Embodiment 20

The method of example embodiment 19, wherein the one or more lookup tables to be programmed into the programmable logic device are based on an expected noise of an image that is associated with a sensor analog gain of an image sensor that captured the image.

1. A system comprising:
an image sensor configurable to capture pixel data; and
a programmable logic device comprising programmable logic circuitry configurable to be programmed with a noise reduction circuit comprising a first bilateral filter and a second bilateral filter, the noise reduction circuit configurable to filter a pixel value of the pixel data based on the first bilateral filter and the second bilateral filter.

2. The system of claim 1, wherein the programmable logic circuitry is configurable to be programmed with a spatial distance lookup table comprising spatial coefficients and an intensity range lookup table comprising intensity coefficients.

3. The system of claim 2, wherein the spatial distance lookup table and the intensity range lookup table correspond to an analog gain of the image sensor.

4. The system of claim 1, wherein the noise reduction circuit is configurable to:
determine a number of weights based on a number of exponents;
determine a weighted average based on the number of weights; and
filter the pixel value based at least on part on the weighted average.

5. The system of claim 1, wherein the noise reduction circuit is configurable to filter the pixel value to reduce an amount of noise present in an image corresponding to the pixel data.

6. The system of claim 5, wherein the noise reduction circuit is configurable to filter the pixel data comprising one-dimensional pixel data or multi-dimensional pixel data.

7. The system of claim 1, wherein the first bilateral filter is associated with a vertical orientation and the second bilateral filter is associated with a horizontal orientation.

8. The system of claim 1, wherein the first bilateral filter is configurable to filter pixel column data of the pixel data and the second bilateral filter is configurable to filter pixel row data of the pixel data.

9. The system of claim 1, wherein the noise reduction circuit is configured to adjust a filtering strength applied to the pixel value when filtering the pixel value based on an intensity of the pixel value.

10. The system of claim 1, wherein the first bilateral filter, the second bilateral filter, or both comprise one or more embedded digital signal processing blocks with one or more multipliers and one or more adders to filter the pixel value.

11. One or more tangible, non-transitory, computer-readable media comprising instructions that, when executed by a data processing system, cause the data processing system to carry out operations comprising:
store pixel data associated with an image;
filter the pixel data based on a first bilateral filter, a second bilateral filter, one or more spatial coefficients, and one or more intensity coefficients; and
output the filtered pixel data to facilitate a reduction of noise present in the image.

12. The one or more tangible, non-transitory, computer-readable media of claim 11, wherein the one or more spatial coefficients are associated with a spatial distance lookup table and the one or more intensity coefficients are associated with an intensity range lookup table.

13. The one or more tangible, non-transitory, computer-readable media of claim 12, wherein the spatial distance lookup table and the intensity range lookup table are associated with an analog sensor gain of an image sensor that captured the image.

14. The one or more tangible, non-transitory, computer-readable media of claim 11, wherein the instructions cause the data processing system to carry out operations comprising adjusting a filtering strength of the pixel data based on an expected amount of noise of the image and pixel intensity of the pixel data.

15. The one or more tangible, non-transitory, computer-readable media of claim 11, wherein the instructions cause the data processing system to carry out operations comprising adjusting a filtering strength of the pixel data based on an analog sensor gain of an image sensor that captured the image.

16. The one or more tangible, non-transitory, computer-readable media of claim 11, wherein the instructions cause the data processing system to carry out operations comprising:
storing pixel column data of the pixel data in a line buffer; and
storing pixel row data of the pixel data in a pixel column buffer.

17. The one or more tangible, non-transitory, computer-readable media of claim 11, wherein the first bilateral filter is associated with a vertical orientation and the second bilateral filter is associated with a horizontal orientation.

18. A method comprising:
using a system design tool or a programmable logic device compiler to generate one or more lookup tables that are to be programmed into a programmable logic device; and
using the system design tool or the programmable logic device compiler to generate a system design comprising a noise reduction circuit configurable to filter a pixel value based on the one or more lookup tables.

19. The method of claim 18, wherein a first lookup table of the one or more lookup tables comprises a spatial distance lookup table and a second lookup table of the one or more lookup tables comprises an intensity range lookup table.

20. The method of claim 19, wherein the one or more lookup tables to be programmed into the programmable logic device are based on an expected noise of an image that is associated with a sensor analog gain of an image sensor that captured the image.
